(19) United States
(12) Patent Application Publication
(10) Pub. No.: US 2019/0082382 A1
(43) Pub. Date: Mar. 14, 2019

(54) ADAPTIVE DISCOVERY PROCESS FOR WIRELESS DEVICES

(71) Applicant: QUALCOMM Incorporated, San Diego, CA (US)

(72) Inventors: Sandip HOMCHAUDHURI, San Jose, CA (US); Hoon Ki LEE, San Jose, CA (US); Pradeep Kumar YENGANTI, Fremont, CA (US); Ramaswamy VENKATESHWARAN, Dublin, CA (US)

(21) Appl. No.: 16/128,411

(22) Filed: Sep. 11, 2018

Related U.S. Application Data
(60) Provisional application No. 62/557,684, filed on Sep. 12, 2017.

(51) Int. Cl. H04W 48/16; H04W 24/10; H04L 12/26; H04W 74/08

(52) U.S. Cl. CPC H04W 48/16; H04W 74/0816; H04L 43/12; H04W 24/10

(57) ABSTRACT

This disclosure generally relates to systems, devices, apparatuses, and methods for providing adaptive discovery timing between wireless devices. A channel is identified for use by a wireless communication device. One or more channel conditions associated with the channel are determined. The system selects a value for a minimum wait time from multiple possible minimum time values based on the one or more channel conditions. In one example, the minimum wait time may represent the amount of time that the wireless communication device will wait before sending a probe request on the channel. In another example, the selected minimum wait time may represent the amount of time that the wireless communication device will remain on the channel after sending the probe request on the channel.

### CROSS-REFERENCE TO RELATED APPLICATION(S)

This application claims the benefit of U.S. Provisional Application Ser. No. 62/557,684, entitled “ADAPTIVE DISCOVERY PROCESS FOR WIRELESS DEVICES” and filed on Sep. 12, 2017, which is expressly incorporated by reference herein in its entirety.

### BACKGROUND

### Field

This disclosure relates generally to wireless communications, and more specifically, to the discovery and association process between wireless devices.

### Background

A wireless local area network (WLAN) may be formed by one or more access points (APs) that provide a shared wireless communication medium for use by one or more client devices, also referred to as stations (STAs). The basic building block of a WLAN conforming to the IEEE 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or maintain a communication link with the WLAN. In a typical WLAN, each STA may be associated with one AP at a time. To identify an AP with which to associate, a STA may wait to receive a beacon frame from an AP or may be configured to perform active scans on the wireless channels of each of one or more frequency bands by sending one or more probe requests to elicit one or more probe responses from one or more APs. For example, a STA may scan one or more channels within the 2.4 GHz band, the 5 GHz band, the 60 GHz band, or any other frequency band available for wireless communications by the STA. Using the information received in a beacon or a probe response, a STA may then select an AP from multiple available APs within range of the STA. After association with an AP, a STA also may be configured to periodically scan its surroundings to find a more suitable AP with which to associate. For example, a STA that is moving relative to its associated AP may perform a “roaming” scan to find an AP having more desirable network characteristics such as a greater received signal strength indicator (RSSI).

In WLAN systems, there is usually a tradeoff between power-efficient AP discovery by STAs and management frame overhead on the network. For power efficient AP discovery, a STA may use active scanning and send one or more probe requests on a channel as soon as the STA accesses the channel for scanning. Sending probe request(s) may elicit probe responses from various APs on the channel. The probe requests and responses from various STAs and APs may add to the management frame overhead on the channel, which may further reduce the usable air-time on the channel for data. On a crowded channel, this management frame overhead may reduce the overall performance of the channel. For example, on particularly crowded channels, management frame overhead may occupy up to 50% of the total channel capacity in some situations. The extra bandwidth used for management frames may decrease the throughput for the primary data flow of the channel. Thus, an improved discovery process between STAs and APs may be desired.

### SUMMARY

The systems, methods and devices of this disclosure each have several innovative aspects, no single one of which is solely responsible for the desirable attributes disclosed herein.

This disclosure generally relates to systems, devices, apparatuses, products, and methods for providing adaptive discovery timing between wireless devices. The apparatus may identify a channel for use by a wireless communication device. The apparatus may determine one or more channel conditions associated with the channel. The apparatus may select, based on the one or more channel conditions, a value for a pre-probe wait time, from multiple possible pre-probe wait time values, for the wireless communication device to wait before sending a probe request on the channel.

In certain other implementations, the apparatus may identify a channel for use by a wireless communication device. The apparatus may determine one or more channel conditions associated with the channel. The apparatus may select, based on the one or more channel conditions, a value for a post-probe wait time, from multiple possible post-probe wait time values, that the wireless communication device will remain on the channel after sending a probe request on the channel. The apparatus may send the probe request on the channel with an indication of the post-probe wait time.

In certain other implementations, the apparatus may identify a channel for use by a wireless communication device. The apparatus may determine one or more channel conditions associated with the channel. The apparatus may select, based on the one or more channel conditions, a value for a minimum wait time from multiple possible minimum wait time values. In certain aspects, the minimum wait time may represent an amount of time that the wireless communication device will wait before sending a probe request on the channel or an amount of time that the wireless communication device will remain on the channel after sending the probe request on the channel. The apparatus may send the probe request on the channel based on the minimum wait time.

In certain other implementations, the apparatus may identify a channel for use by a wireless communication device. The apparatus may determine one or more channel conditions associated with the channel. The apparatus may select, based on the one or more channel conditions, a value for a pre-probe wait time, from multiple possible pre-probe wait time values, for the wireless communication device to wait before sending a probe request on the channel. The apparatus may select, based on the one or more channel conditions, a value for a post-probe wait time, from multiple possible post-probe wait time values, that the wireless communication device will remain on the channel after sending the probe request on the channel. The apparatus may send the probe request on the channel after expiration of the pre-probe wait time with an indication of the post-probe wait time.

Details of one or more implementations of the subject matter described in this disclosure are set forth in the accompanying drawings and the description below. Other features, aspects, and advantages will become apparent from the description, the drawings and the claims.

### BRIEF DESCRIPTION OF THE DRAWINGS

The system may be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a schematic diagram illustrating an example of a wireless local area network (WLAN) deployment.

FIG. 2 is a diagram illustrating a discovery sequence between a STA and one or more APs.

FIG. 3 is a schematic diagram of a communication network including aspects of an AP configured for discovery and association with STAs in accordance with various aspects of the present disclosure.

FIG. 4 is a schematic diagram of a communication network including aspects of a STA configured for discovery and association with APs in accordance with various aspects of the present disclosure.

FIG. 5 is a flow diagram illustrating an example technique for determining a pre-probe wait time in accordance with various aspects of the present disclosure.

FIG. 6 is a flow diagram illustrating an example technique for determining an post-probe wait time in accordance with various aspects of the present disclosure.

FIG. 7 is a flow diagram illustrating an example technique for determining whether stored data may be used to calculate a pre-probe wait time and/or a post-probe wait time in accordance with various aspects of the present disclosure.

FIG. 8 is a conceptual data flow diagram illustrating the data flow between different means/components in an exemplary apparatus.

FIG. 9 is a diagram illustrating an example of a hardware implementation for an apparatus employing a processing system.

FIG. 10 is a conceptual data flow diagram illustrating the data flow between different means/components in an exemplary apparatus.

FIG. 11 is a diagram illustrating an example of a hardware implementation for an apparatus employing a processing system.

FIG. 12 is a conceptual data flow diagram illustrating the data flow between different means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

The systems and techniques described in this detailed description provide an adaptive discovery process for wireless communication devices, such as when a station (“STA”) seeks to discover an access point (“AP”) that could provide wireless local area network (“WLAN”) coverage to the STA. Some device discovery processes consume a relatively large amount of STA power. Other discovery processes flood the network with relatively large numbers of overhead management frames which add to the overall network congestion. As will be discussed in more detail below, the systems described herein provide an adjustable balance between the amount of power used by a device during the discovery and association process and the amount of overhead management frames created during the discovery and association process.

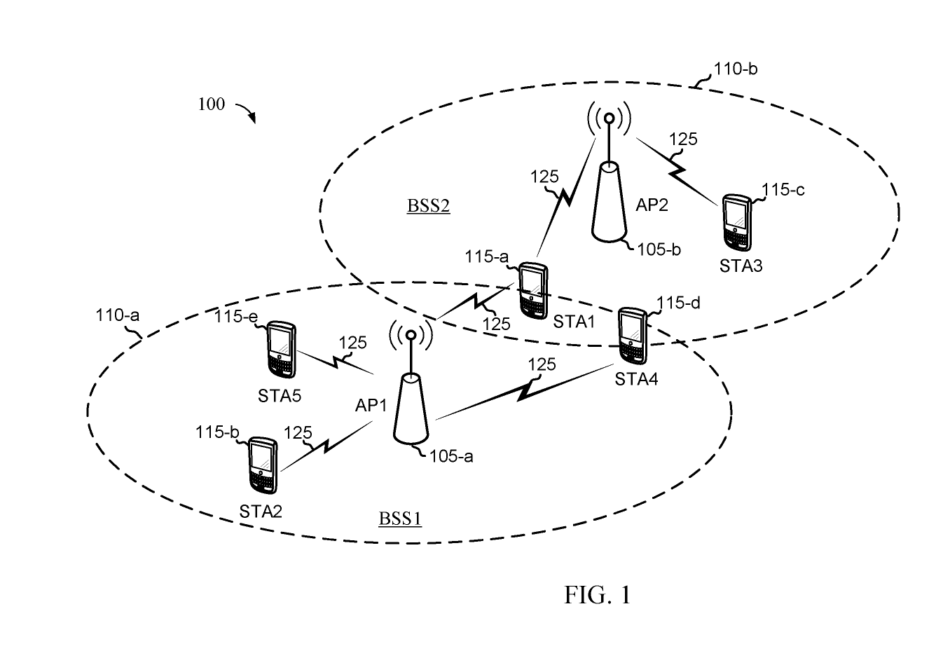

FIG. 1 is a wireless communication system 100 illustrating an example of a wireless local area network (WLAN) deployment in connection with various techniques described herein for an adaptive discovery process that allows dynamic adjustment of various discovery time periods to balance power consumption and management frame overhead. The WLAN deployment may include one or more access points (APs) and one or more wireless stations (STAs) associated with a respective AP. In the example illustrated in FIG. 1, there are two APs deployed for illustrative purposes: AP1 105-a in basic service set 1 (BSS1) and AP2 105-b in BSS2. AP1 105-a is shown having multiple associated STAs (STA1 115-a, STA2 115-b, STA4 115-d, and STA5 115-e) and coverage area 110-a, while AP2 105-b is shown having multiple associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of both coverage areas 110-a, 110-b. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

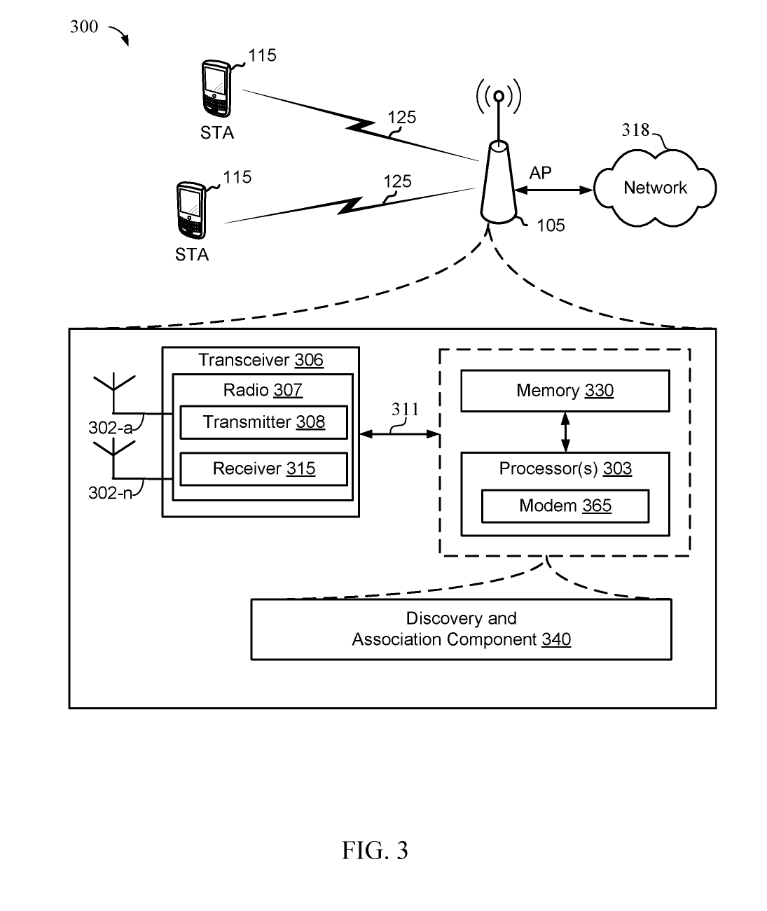

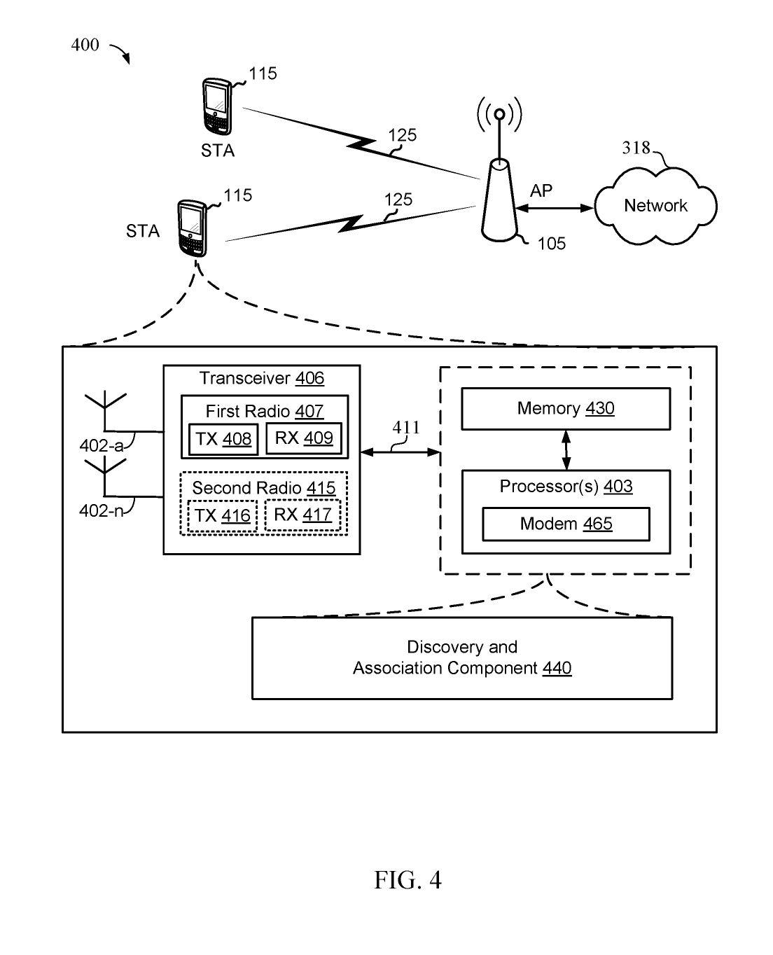

The APs (e.g., AP1 105-a and AP2 105-b) shown in FIG. 1 may include fixed terminals that provide backhaul services to STAs within its coverage area or region. In some applications, however, the AP may be a mobile or non-fixed terminal. The STAs (e.g., STA1 115-a, STA2 115-b, STA3 115-c, STA4 115-d, and STA5 115-e) shown in FIG. 1, which may be fixed, non-fixed, or mobile terminals, utilize the backhaul services of their respective AP to connect to a network (see, e.g., network 318 in FIGS. 3 and 4), such as the Internet. Examples of a STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. A STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STA5 115-e may be implemented with a protocol stack. The protocol stack may include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers that may be used for establishing or supporting a connection to a network.

Each of AP1 105-a and AP2 105-b may include software applications and/or circuitry to enable associated STAs to connect to a network via communications links 125. The APs may each send frames to their respective STAs and receive frames from their respective STAs to communicate data and/or control information (e.g., signaling).

Each of AP1 105-a and AP2 105-b may establish a communications link 125 with a STA that is within the coverage area of the AP. Communications links 125 may include communications channels that enable both uplink and downlink communications. When connecting to an AP, a STA can first authenticate itself with the AP and then associate itself with the AP. Once associated, a communications link 125 may be established between the AP and the STA such that the AP and the associated STA are able to exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN, and other technologies used in wide area networks (WANs), cellular networks, WLANs, personal area networks (PAN)s, or other suitable networks now known or later developed.

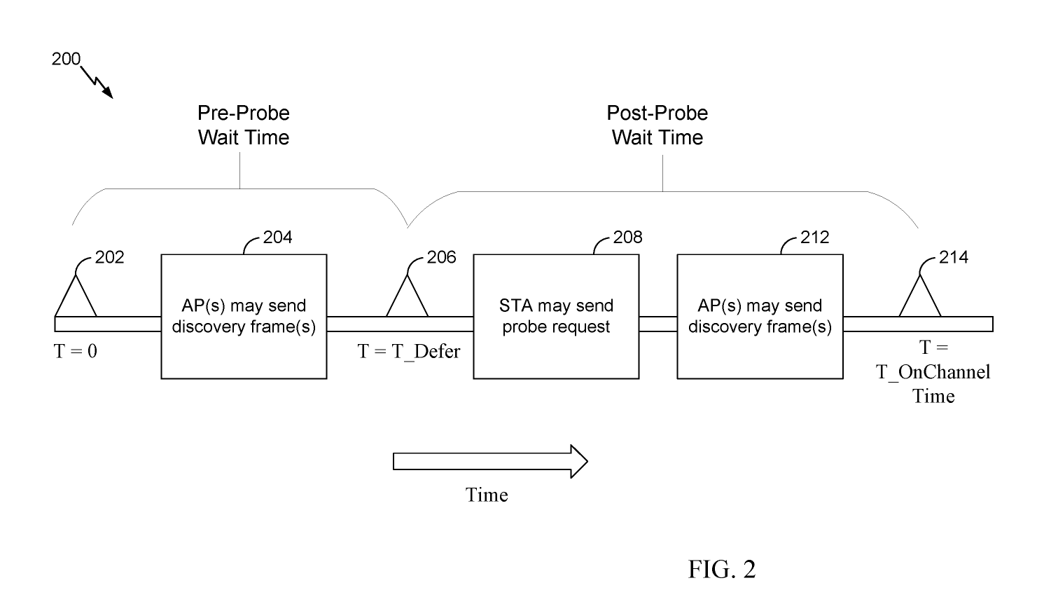

FIG. 2 is a time sequence diagram illustrating a discovery process 200 between a STA and one or more APs. In Wi-Fi networks, such as the one shown in FIG. 1, there may be a tradeoff between power efficiency and management frame efficiency. To reduce the amount of power consumed for discovering an AP, a STA may use active scanning and send one or more probe requests on a channel upon tuning to the channel. By sending the probe request immediately after tuning to the channel instead of first waiting on the channel in an active listening state, the STA may reduce power output that would otherwise be used waiting on the channel and running receive processing algorithms for possible incoming frames. Conversely, by sending immediate probe requests (and the resulting probe responses), the management frame overhead on the channel may be increased, which further reduces the usable air-time on the channel for data communications (e.g., the data throughput of the channel may be reduced).

In effort to alleviate some of the management frame overhead, some systems mandate a fixed wait time before a STA can send a probe request on the channel. In some implementations, the fixed wait time may be 15 milliseconds. The fixed wait time may be the time between event 202 (e.g., the STA tuning to a channel at time T=0) and event 206 (e.g., the expiration of the wait time at T=T_Defer). The hope is that the STA will receive the needed discovery information without having to send out a probe request at all. For example, the STA may receive a beacon frame (or another discovery frame) from an AP during the wait interval at block 204 that will render the probe request/response exchange unnecessary. If the STA determines that a probe request is needed after the expiration of the wait period at event 206, then the STA may send a probe request at block 208.

When a probe request is sent, some systems also mandate a fixed amount of time that the STA must remain on a channel after the probe request is sent. In some implementations, the fixed wait time may be 10 milliseconds, although other implementations will be pre-programmed with a different fixed value higher than 10 milliseconds. The fixed wait time may be the time between event 206/208 (e.g., the STA sending the probe request at block 208 after the expiration of the pre-probe wait time at event 206) and event 214 (e.g., the expiration of the wait time at T=T_OnChannelTime). During this wait time, one or more APs may respond to the probe request, or otherwise provide discovery information during block 212. Using the technique described above in connection with FIG. 2, the management frame overhead may be reduced if an AP waits until toward the end of the guaranteed on-channel time before responding to a received probe request. For example, the AP may receive multiple probe requests from multiple STAs during this post-probe waiting period and can combine, aggregate, or consolidate multiple individual probe responses into an aggregated or consolidated response, such as by sending a broadcast probe response or some other type of response that will provide the discovery information to more than one STA at the same time.

Although the fixed pre-probe wait time value and the fixed post-probe time value may reduce some management frame overhead in some situations, the fixed pre-probe wait time and fixed post-probe wait time may have a negative impact on the power consumption of the STA, especially battery-powered STAs. With these fixed wait times, the STA may remain on the channel with its radio enabled in listen mode for those time periods (e.g., pre-probe and post-probe) during each scan procedure. In some situations, this may unnecessarily consume power and may also negatively impact the time taken by the STA to discover APs in the vicinity.

In order to provide a solution, the present disclosure provides a technique in which a system may use adjustable values for the pre-probe wait time value and/or the post-probe on-channel time. The value of these listening time periods may be set dynamically based on one or more channel conditions. Thus, when conditions are favorable, the time periods may be made shorter (thus saving power at times when frame overhead is not as much of a concern) and when conditions are less favorable, the time periods may be made longer (thus reducing frame overhead when it may be more important to do so), e.g., as described below in connection with any of FIGS. 3-13.

FIG. 3 illustrates an example wireless communication system 300 that includes multiple STAs 115 in wireless communication with at least one AP 105 connected to network 318. The STAs 115 may communicate with network 318 via AP 105. In an example, STAs 115 may transmit and/or receive wireless communications to and/or from AP 105 via one or more communication links 125. Such wireless communications may include, but are not limited to, data, audio and/or video information. In some instances, such wireless communications may include control or similar information. An AP, such as AP 105, may be configured to perform the adaptive discovery process techniques described herein for dynamically setting the wait times associated with a discovery process. The AP may exchange discovery frames according to the timing set by the STA, or it may itself set the timing for its own discovery process with another AP.

In accordance with the present disclosure, AP 105 may include a memory 330, one or more processors 303 and a transceiver 306. The memory 330, the one or more processors 303 and the transceiver 306 may communicate internally via a bus 311. In some examples, the memory 330 and the one or more processors 303 may be part of the same hardware component (e.g., may be part of a same board, integrated circuit, etc.). Alternatively, the memory 330 and the one or more processors 303 may be separate components that may act in conjunction with one another. The bus 311 may be a communication system that transfers data between multiple components and subcomponents of the AP 105. In some examples, the one or more processors 303 may include any one or a combination of modem processor, baseband processor, digital signal processor, and/or transmit processor. Additionally or alternatively, the one or more processors 303 may include a modem 365 with a discovery and association component 340 that carries out one or more methods or procedures described herein in connection with an AP. The discovery and association component 340 may comprise hardware, firmware, and/or software and may be configured to execute code or perform instructions stored in a memory (e.g., a computer-readable storage medium).

In some examples, the memory 330 may be configured for storing data that is used in connection with local applications, and/or in connection with the discovery and association component 340 and/or one or more of any subcomponents being executed by the one or more processors 303. Memory 330 may include any type of computer-readable medium usable by a computer or processor 303, such as random access memory (RAM), read only memory (ROM), tapes, magnetic discs, optical discs, volatile memory, non-volatile memory, and any combination thereof. In an aspect, for example, memory 330 may be a computer-readable storage medium (e.g., a non-transitory medium) that stores computer-executable code. The computer-executable code may define one or more operations or functions of the broadcast discovery and association component 340 and/or one or more of any subcomponents, and/or data associated therewith. The computer-executable code may define these one or more operations or functions when AP 105 is using processor 303 to execute the discovery and association component 340 and/or one or more of any subcomponents.

In some examples, the AP 105 may further include a transceiver 306 for transmitting and/or receiving one or more data and control signals (e.g., messages) to/from a STA 115. For example, the AP 105 may transmit probe responses, broadcast probe responses, beacons, Fast Initial Link Setup (FILS) discovery frames, or other discovery and association frames. The transceiver 306 may comprise hardware, firmware, and/or software and may be configured to execute code or perform instructions stored in a memory (e.g., a computer-readable storage medium). The transceiver 306 may include one or more radios, including a radio 307 comprising a transmitter 308 and a receiver 315. The radio 307 may utilize one or more antennas 302 (e.g., antennas 302-a, . . . , 302-n) for transmitting signals to and receiving signals from a plurality of STAs 115. The receiver 315 may include one or more components that form a receiving chain and the transmitter 308 may include one or more components that form a transmitting chain.

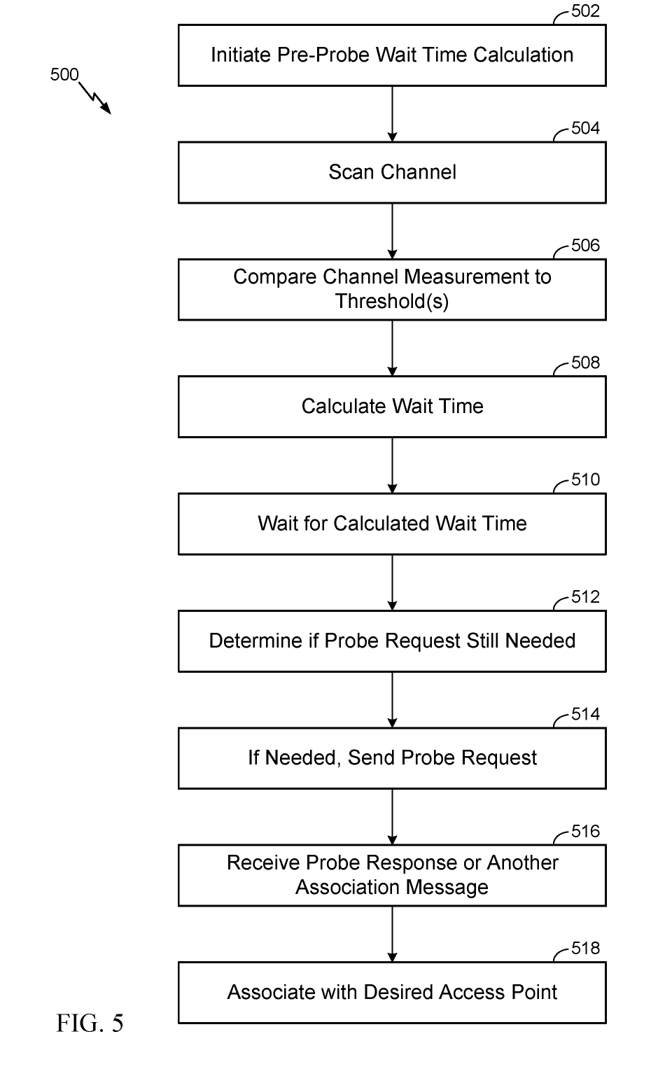

The discovery and association component 340 may be configured to perform, alone or in combination with other components of the AP 105, at least the AP-side functions described in connection with the flow diagrams of FIGS. 5-7.

FIG. 4 illustrates an example wireless communication system 400 similar to the wireless communication system 300 in FIG. 3. One or more of the STAs 115 may be configured to participate in the adaptive discovery process described herein.

In accordance with the present disclosure, a STA 115 may include a memory 430, one or more processors 403 and a transceiver 406. The memory 430, the one or more processors 403 and the transceiver 406 may communicate internally via a bus 411. In some examples, the memory 430 and the one or more processors 403 may be part of the same hardware component (e.g., may be part of a same board, module, or integrated circuit). Alternatively, the memory 430 and the one or more processors 403 may be separate components that may act in conjunction with one another. The bus 411 may be a communication system that transfers data between multiple components and subcomponents of the STA 115. In some examples, the one or more processors 403 may include any one or combination of modem processor, baseband processor, digital signal processor, and/or transmit processor. Additionally or alternatively, the one or more processors 403 may include a modem 465 having a discovery and association component 440 for carrying out one or more methods or procedures described herein in connection with a STA. The discovery and association component 440 may comprise hardware, firmware, and/or software and may be configured to execute code or perform instructions stored in a memory (e.g., a computer-readable storage medium).

In some examples, the memory 430 may be configured for storing data that is used in connection with local applications, and/or in connection with the discovery and association component 440 and/or one or more of any subcomponents being executed by the one or more processors 403. Memory 430 can include any type of computer-readable medium usable by a computer or processor 403, such as random access memory (RAM), read only memory (ROM), tapes, magnetic discs, optical discs, volatile memory, non-volatile memory, and any combination thereof. In an aspect, for example, memory 430 may be a computer-readable storage medium (e.g., a non-transitory medium) that stores computer-executable code. The computer-executable code may define one or more operations or functions of the discovery and association component 440 and/or one or more of any subcomponents, and/or data associated therewith. The computer-executable code may define these one or more operations or functions when STA 115 is using processor 403 to execute the discovery and association component 440 and/or one or more of any subcomponents. In some examples, the STA 115 may further include a transceiver 406 for transmitting and/or receiving one or more data and control signals (e.g., messages) to/from a STA and/or AP 105. The transceiver 406 may comprise hardware, firmware, and/or software and may be configured to execute code or perform instructions stored in a memory (e.g., a computer-readable storage medium). The transceiver 406 may include multiple radios that enable the STA 115 to operate as a multi-mode device or client. In this example, the transceiver 406 may include a first radio 407 having a transmitter (TX) 408 and a receiver (RX) 409, and a second radio 415 having a TX 416 and a RX 417. The first radio 407 may be a WLAN or Wi-Fi radio and the second radio 415 may be a non-WLAN system or non-Wi-Fi system radio (e.g., an LAA radio, an LTE-U radio).

Each of the first radio 407 and the second radio 415 may utilize one or more antennas 402 (e.g., antennas 402-a, . . . , 402-n) for transmitting signals to and receiving signals from an AP 105. The receivers 409 and 417 may include one or more components that form a receiving chain, and the transmitters 408 and 416 may include one or more components that form a transmitting chain.

The discovery and association component 440 may be configured to perform, alone or in combination with other components of the STA 115, at least the STA-side functions described in connection with the flow diagrams of FIGS. 5-7.

Referring to FIGS. 5-7, examples of one or more operations related to the AP 105 (FIG. 3) and the STA 115 (FIG. 4) are described with reference to one or more methods and one or more components. Although the operations described below are presented in a particular order and/or as being performed by an example component, it should be understood that the ordering of the operations and the components performing the actions may be varied, depending on the implementation. Moreover, it should be understood that the following operations may be performed by a specially-programmed processor, a processor executing specially-programmed software or computer-readable media, or by any other combination of a hardware component and/or a software component specially configured for performing the described actions or components. For example, the various steps shown in FIGS. 5-7 may be performed by a processor (e.g., processor 303 for AP-side functions or processor 403 for STA-side functions) coupled with memory (e.g., memory 330 for AP-side functions or memory 430 for STA-side functions) that stores instructions executable by the processor to perform the described action. Other STA or AP sub-components may also be involved in each step, such as transceivers and antennas for any reception and/or transmission operations.

FIG. 5 is a flow diagram illustrating an example of an adaptive discovery and association process 500, in accordance with various aspects of the present disclosure. At block 502, a wireless communication device, such as a STA (for AP discovery) or an AP (for discovering another AP) may initiate a pre-probe wait time calculation. Note that for the remainder of the description of this flow diagram, a STA will be described as the wireless communication device initiating the discovery sequence, although other implementations may be initiated by an AP. The pre-probe wait time (e.g., also referred to as T_Defer) represents the minimum amount of time that the STA will wait before sending a probe response. For example, the pre-probe wait time may be the amount of time the STA must wait between tuning to a specific channel and sending a probe request on that channel. As another example, for a roaming scan implementation, the pre-probe wait time may be the amount of time the STA must wait between deciding a scan will be performed (e.g., the RSSI of its current AP drops below some scan triggering threshold) and the event of sending a probe request on the same channel. The exact time at which the pre-probe wait timer will start may vary according to different implementations. The STA, however, may await expiration of the timer before sending any probe request on the channel.

At block 504, the STA may scan the chosen channel to determine the current channel conditions, such as by measuring one or more channel condition metrics. The scan at block 504 may be performed during a short initial waiting period where the STA defers sending a probe request until the channel conditions can be determined. The channel conditions may then be used to determine whether further wait time (in addition to the short initial waiting time that is set to be just long enough for the STA to perform the scan procedure itself) is advisable or needed.

As one example, the channel scan may measure one or more conditions that may be used to determine a Clear Channel Assessment (CCA) value that indicates the congestion level on the channel. The CCA may indicate the amount of the channel that is congested, such as a percentage of the channel that is congested. The CCA may count the amount of time over several samples that is congested or clear and calculate a percentage based on the samples measured. In other implementations, different channel conditions may be used. For example, instead of looking purely at congestion or energy witnessed on the channel, the STA could analyze expected interference and calculate a channel condition value based on expected amount of interference.

In still other implementations, other alternative channel conditions may be obtained and used to calculate the appropriate amount of pre-probe wait time. As one alternative example, if the STA receives a request to send (RTS) and/or clear to send (CTS) frame on the channel during the initial waiting time during scanning, information from the RTS and/or CTS frame could be used to determine a channel condition value that is then used to calculate the pre-probe wait time. An RTS or CTS frame may indicate whether a channel is occupied in some manner. For example, the frame may block the channel for a specified amount of time. The channel reservation time may not fully appear in a traditional CCA metric during reserved time when no energy is experienced on the channel. The knowledge of the RTS or CTS information may be used to calculate a more accurate indication of congestion or potential congestion on the channel. The calculation of congestion or potential congestion may then be used to select the appropriate pre-probe wait time.

As another alternative example, if the STA receives a beacon, FILS Discovery frame, or another management frame on the channel, the received frame may indicate what types of APs are using the channel. The STA may determine that based on the information whether to seek out an AP on a different channel, and thus, prefer to leave the channel as soon as possible. The information may also be used to adjust (e.g., shorten) the overall time spent on the channel, such as shortening the pre-probe wait time at which point the STA may leave the channel without sending a probe request at all.

At block 506, the STA may compare a channel condition value (e.g., a CCA value or an alternative value that represents the conditions on the channel, such as congestion) to one or more predetermined thresholds. In one implementation, one threshold may be used to provide two different pre-probe wait time value possibilities. In another implementation, two thresholds may be used to provide three different pre-probe wait time value possibilities. In other implementations, more than two thresholds may be used to provide the desired resolution level for varying amounts of possible pre-probe wait times.

At block 508, the STA may calculate the appropriate pre-probe wait time depending on channel conditions. As one example, the STA may select a shorter amount of pre-probe wait time if the one or more channel conditions indicate a relatively lower congestion level than if the one or more channel conditions indicated a relatively higher congestion level. Having the ability to set a shorter pre-probe wait time when a channel is relatively uncongested allows greater power savings at a time when management frame overhead is less of a concern. For example, at times when the channel is not very congested, the negative impact of the management frame overhead from the probe request/response sequence may be acceptable to the overall performance of the channel. A shorter pre-probe wait time may save some power for the STA that would otherwise use power to actively listen to the channel for a longer period.

Conversely, having the ability to set a longer pre-probe wait time when a channel is relatively congested gives up some power savings at a time when management frame overhead is more of the primary concern. For example, at times when the channel is highly congested, the negative impact of the management frame overhead from the probe request/response sequence may not be acceptable to the desired network performance goals. In some implementations, where the channel conditions are favorable (e.g., not congested), the STA may determine that no additional wait time is needed and may initiate a probe request transmission immediately after the initial wait time. In other situations, where the channel conditions are less favorable (e.g., some degree of congestion), then the STA may add additional wait time on top of the initial wait time during which the channel scan occurred. The amount of additional wait time may progressively increase as the amount of congestion increases.

At block 508, in some implementations, the STA may calculate the appropriate pre-probe wait time based on the results of the threshold comparison at block 506. In implementations with one threshold, the STA may select between the pre-probe wait time value being a first time value or a second time value, different than the first time value, depending on whether the channel condition value is above the first threshold or below the first threshold. For example, when a low channel condition value on the scale indicates a congested channel, a longer wait time may be selected when the channel condition value is below the threshold than when the channel condition value is above the threshold. Alternatively, when a high channel condition value on the scale indicates a congested channel, a longer wait time may be selected when the channel condition value is above the threshold than when the channel condition value is below the threshold.

In implementations with two thresholds, the STA may select between the pre-probe wait time value being a first time value, a second time value different that the first time value, or a third time value different than the first and second time values, depending on whether the channel condition value is below the first threshold, above the second threshold, or between the first and second thresholds. For example, when a low channel condition value on the scale indicates a congested channel, a longest wait time may be selected when the channel condition value is below the first threshold, a middle wait time may be selected when the channel condition value is between the first and second thresholds, and a shortest wait time may be selected when the condition value is above the second threshold. Alternatively, when a high channel condition value on the scale indicates a congested channel, a shortest wait time may be selected when the channel condition value is below the first threshold, a middle wait time may be selected when the channel condition value is between the first and second thresholds, and a longest wait time may be selected when the condition value is above the second threshold. Any number of thresholds and any number of resulting wait time values may be possible according to a similar N threshold comparison technique resulting in N+1 possible wait times, where N represents any number.

In one example implementation, the STA may use two congestion thresholds with three resulting possible pre-probe wait times. The first threshold may correspond to a 15% congestion level on the channel. The second threshold may correspond to a 30% congestion level on the channel. If the measured congestion is below 15%, then the STA may set a 5-millisecond pre-probe wait time. If the measured congestion is above 15% but below 30%, then the STA may set a 10-millisecond pre-probe wait time. If the measured congestion is above 30%, then the STA may set a 15-millisecond pre-probe wait time. Other implementations may use different threshold numbers or may use different resulting wait time amounts. For example, some implementations may include an option for a 0-millisecond pre-probe wait time when the channel is particularly clear or uncongested.

At block 510, the STA may wait for the amount of wait time calculated at block 508 before transmitting any probe requests (or any similar discovery response trigger frames, which are intended to be within the scope of the term probe request). During the wait time of block 510, the STA may be actively listening for any incoming discovery frames.

At block 512, the STA may determine whether any additional discovery information is needed to complete a desired AP association. For example, the STA may analyze any information received during the calculated wait time and determine if a suitable AP has provided its information. In some implementations, the STA may have received a beacon frame, a broadcast probe response frame, a Fast Initial Link Setup (FILS) frame, or a similar discovery frame before expiration of the wait time without sending out any probe request frame. In an instance where the STA selects and associates with an AP that sent a beacon frame, a broadcast probe response frame, or a FILS frame, the STA may determine not to send any probe request at this time because it would be unnecessary to achieve the STA's desired level of service. For example, the STA may compare the performance or quality data (e.g., RSSI or other data) of the AP associated with the received discovery frame against one or more internal performance thresholds and determine that the AP is good enough for the service it seeks. In this case, the STA may skip the probe request/response sequence and avoid the resulting management frame channel overhead.

Alternatively, at block 512, the STA may determine that either (1) it did not receive any discovery frames during the designated wait time, or (2) that the received discovery frame(s) were associated with APs that did not meet its desired level of service or performance (e.g., by comparing the received data with its pre-stored performance thresholds). In this situation, the STA may send a probe request at block 514. For example, the STA may use its transmitter and antenna to send out the probe request to one or more APs in the vicinity of the STA. If the STA received any discovery frames from APs during the designated wait time, but did not select those APs, then the STA may identify those APs in an information element of the probe request so that those APs can suppress any probe responses that would otherwise be triggered by the probe request. The suppression indication may cut down on duplication of discovery messages/information that would otherwise result from a probe response that did not include the suppression element. The suppression indication may be an SSID or a list of SSIDs that correspond to the APs that should suppress a response.

At block 516, the STA may receive one or more probe responses or other discovery responses. For example, the received probe response may be addressed directly to the STA that sent the probe request or the probe response may be a broadcast probe response triggered at the AP based on the probe request from the STA or a probe request received from a different STA. Alternatively, the STA may also happen to have received a beacon or FILS frame from an AP during this time window that may not have been triggered by the probe request. At block 518, the STA may analyze the received discovery data and selects the desired AP for association that meets its performance standards, requested service type, or any other qualification standards.

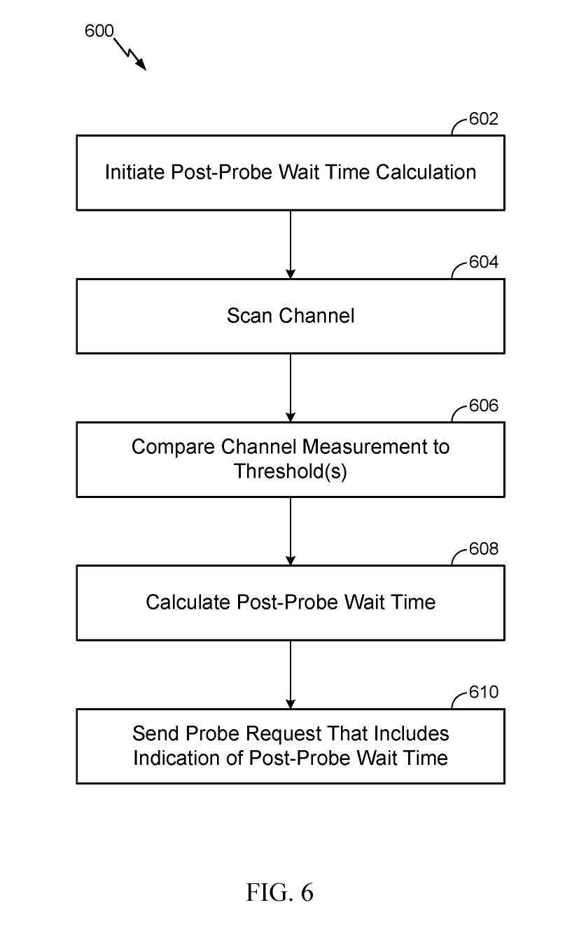

FIG. 6 is a flow diagram illustrating an example of an adaptive discovery and association process 600, in accordance with various aspects of the present disclosure. At block 602, a wireless communication device, such as a STA (for AP discovery) or an AP (for discovering another AP) initiates a post-probe wait time calculation. Note that for the remainder of the description of this flow diagram, a STA will be described as the wireless communication device initiating the discovery sequence, although other implementations may be initiated by an AP. The post-probe wait time (e.g., also referred to as on-channel time or T_OnChannelTime) represents the minimum amount of time that the STA will wait for a response on the channel after sending the probe request on the channel. For example, the post-probe wait time may be the amount of time the STA must wait and actively listen to the channel between sending the probe request and leaving the channel to try a different channel. The exact time at which the post-probe wait timer will start and stop may vary according to different implementations. The STA, however, will generally await expiration of the timer before leaving the channel.

At block 604, the STA may scan the chosen channel to determine the current channel conditions, such as by measuring one or more channel condition metrics. For example, the channel scan may measure one or more conditions that may be used to determine a Clear Channel Assessment (CCA) value that indicates the congestion level on the channel. The CCA may indicate the amount of the channel that is congested, such as a percentage of the channel that is congested. The CCA may count the amount of time over several samples that is congested or clear and calculate a percentage based on the samples measured. In other implementations, different channel conditions may be used. For example, instead of looking purely at congestion or energy witnessed on the channel, the STA could analyze expected interference and calculate a channel condition value based on expected amount of interference. In still other alternative implementations, other channel conditions may be obtained and used to calculate the appropriate amount of post-probe wait time. As one alternative example, if the STA receives a request to send (RTS) and/or clear to send (CTS) frame on the channel during the initial waiting time during scanning, information from the RTS and/or CTS frame could be used to determine a channel condition value that is then used to calculate the post-probe wait time. An RTS or CTS frame may indicate whether a channel is occupied in some manner. For example, the frame may block the channel for a specified amount of time. This channel reservation time may not fully appear in a traditional CCA metric during reserved time when no energy is experienced on the channel. The knowledge of the RTS or CTS information may be used to calculate a more accurate indication of congestion or potential congestion on the channel. This calculation may then be used to select the appropriate post-probe wait time.

In some implementations where the STA scans a channel for the pre-probe wait time calculation (as in block 504 of FIG. 5), the same channel condition data acquired at block 504 may be reused for the post-probe wait time calculation for block 604. Alternatively, other types of data may be used or new scans may be performed.

At block 606, the STA compares a channel condition value (e.g., a CCA value or an alternative value that represents the conditions on the channel, such as congestion) to one or more predetermined thresholds. In one implementation, one threshold may be used to provide two different post-probe wait time value possibilities. In another implementation, two thresholds may be used to provide three different post-probe wait time value possibilities. In other implementations, more than two thresholds may be used to provide the desired resolution level for varying amounts of possible post-probe wait times.

At block 608, the STA calculates the appropriate post-probe wait time depending on channel conditions. As one example, the STA may select a shorter amount of post-probe wait time if the one or more channel conditions indicate a relatively lower congestion level than if the one or more channel conditions indicated a relatively higher congestion level. Having the ability to have a shorter post-probe wait time when a channel is relatively uncongested allows power savings at a time when management frame overhead is less of a concern. For example, at times when the channel is not very congested, the negative impact of the management frame overhead from forcing the AP to respond to the probe request sooner (and thus having less chance to save overhead through aggregating or consolidating multiple probe responses) may be acceptable to the overall performance of the channel. A shorter post-probe wait time may save some power for the STA that would otherwise use power to actively listen to the channel for a longer period. On the other side, having the ability to have a longer post-probe wait time when a channel is relatively congested gives up some power savings at a time when management frame overhead is more of the primary concern (with a longer post-probe wait period in this situation it may be more likely there could be management frame overhead savings through aggregating or consolidating probe responses). For example, at times when the channel is highly congested, the negative impact of the management frame overhead from more separated and individualized probe responses may not acceptable in view of the power savings potential.

At block 608, in some implementations, the STA may calculate the appropriate post-probe wait time based on the results of the threshold comparison at block 606. In implementations with one threshold, the STA may select between the post-probe wait time value being a first time value or a second time value, different than the first time value, depending on whether the channel condition value is above the first threshold or below the first threshold. For example, when a low channel condition value on the scale indicates a congested channel, a longer wait time may be selected when the channel condition value is below the threshold than when the channel condition value is above the threshold. Alternatively, when a high channel condition value on the scale indicates a congested channel, a longer wait time may be selected when the channel condition value is above the threshold than when the channel condition value is below the threshold.

In implementations with two thresholds, the STA may select between the post-probe wait time value being a first time value, a second time value different that the first time value, or a third time value different than the first and second time values, depending on whether the channel condition value is below the first threshold, above the second threshold, or between the first and second thresholds. For example, when a low channel condition value on the scale indicates a congested channel, a longest wait time may be selected when the channel condition value is below the first threshold, a middle wait time may be selected when the channel condition value is between the first and second thresholds, and a shortest wait time may be selected when the condition value is above the second threshold. Alternatively, when a high channel condition value on the scale indicates a congested channel, a shortest wait time may be selected when the channel condition value is below the first threshold, a middle wait time may be selected when the channel condition value is between the first and second thresholds, and a highest wait time may be selected when the condition value is above the second threshold. Any number of thresholds and any number of resulting values are possible according to a similar N threshold comparison technique resulting in N+1 possible wait times, where N represents any number.

In one example implementation, the STA may use three congestion thresholds with four resulting possible post-probe wait times. The first threshold may correspond to a 15 percent congestion level on the channel. The second threshold may correspond to a 30 percent congestion level on the channel. The third threshold may correspond to a 60 percent congestion level on the channel. If the measured congestion is below 15%, then the STA may set a 5-millisecond post-probe wait time. If the measured congestion is above 15% but below 30%, then the STA may set a 10-millisecond post-probe wait time. If the measured congestion is above 30% but below 60%, then the STA may set a 20-millisecond pre-probe wait time. If the measured congestion is above 60%, then the STA may set a 30-millisecond pre-probe wait time. Other implementations may use different threshold numbers or may use different resulting wait time amounts.

At block 610, the STA sends a probe request on the channel. The STA includes an information element in the probe request that indicates the value of the calculated post-probe wait time. For example, the STA will use this information element to indicate to any receiving APs the amount of time it expects to be on the channel waiting for discovery responses. The receiving APs can then use this time indication to schedule responses at times that increase the potential of finding efficiencies of aggregating or consolidating the probe response with responses to other probing STAs. For example, the AP may wait until towards the end of the indicated post-probe wait time and then send a broadcast probe response or another type of aggregated response that will provide discovery information to multiple probing STAs. The STA sending the probe request may include the exact calculated minimum post-probe wait time in the probe request frame to the APs, or in other implementations the STA may use an even longer value to provide some extra buffer time.

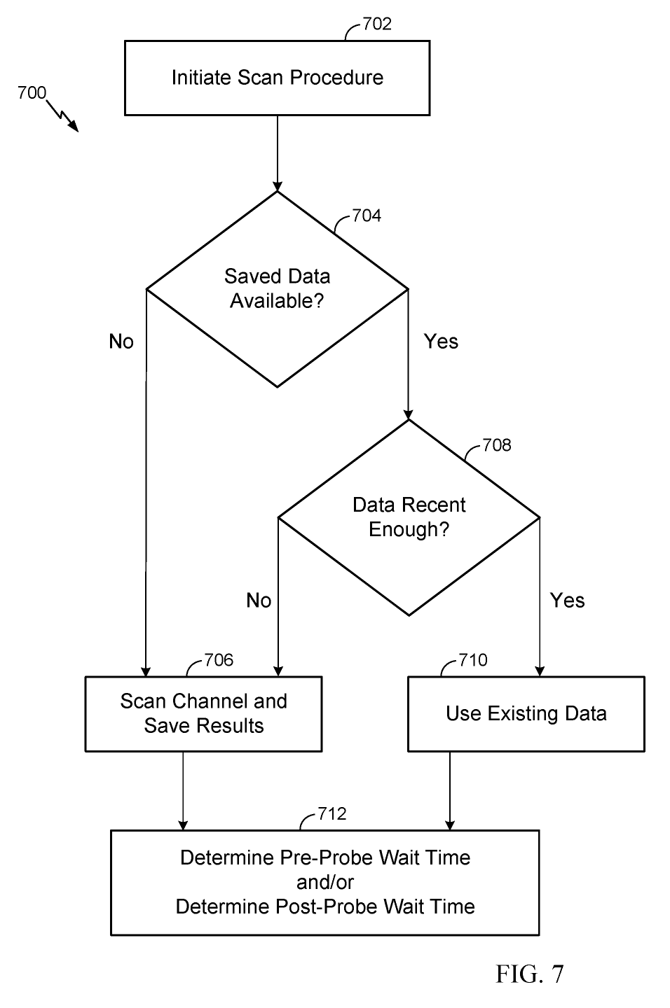

FIG. 7 is a flow diagram illustrating an example of an adaptive discovery and association process 700, in accordance with various aspects of the present disclosure. At block 702, a wireless communication device, such as a STA (for AP discovery) or an AP (for discovering another AP) initiates a scan procedure. Note that for the remainder of the description of this flow diagram, a STA will be described as the wireless communication device initiating the scan procedure sequence, although other implementations may be initiated by an AP. The flow diagram of FIG. 7 may provide an alternative way to acquire data regarding the conditions of the selected channel in contrast to the channel scan and measurement process described at block 504 of FIG. 5 and block 604 of FIG. 6. In the process of FIG. 7, the STA may skip the channel scan and measurement process and instead rely on previously captured and stored data.

At block 704, the STA determines if saved data is available. For example, the STA may access a database, memory, or lookup table to determine whether there is any stored channel condition information available for the specific channel at issue. If no stored channel condition data is available, then block 704 proceeds to block 706 where the STA initiates a channel scan procedure (as described in connection with block 504 of FIG. 5 and block 604 of FIG. 6). The results of the scan are then saved for future use, which may save future scan cycles if further channel analysis is needed.

Alternatively, if stored channel condition information is located, then block 704 proceeds to block 708 where the STA determines whether the stored information is recent enough to be a reliable indicator of the current channel conditions. In some implementations, the STA may maintain a predetermined threshold time value that is compared against a time stamp associated with the stored data. The threshold may be set to 5 seconds or 10 seconds in some implementations (e.g., fairly dynamic environments), 5 minutes or 10 minutes in other implementations (e.g., fairly static environments), but other implementations may use different threshold values. If the amount of time that has passed between the time stamp and the current time is greater than the threshold, then block 708 proceeds to block 706 where the STA may initiate a channel scan procedure (as described in connection with block 504 of FIG. 5 and block 604 of FIG. 6).

Alternatively, if the amount of time that has passed between the time stamp and the current time is less than the threshold, then block 708 proceeds to block 710 where the STA will use the stored data instead of requiring a new channel scan. In some implementations, the threshold used to determine whether the age of the stored data is short enough may be a dynamic threshold that changes based on one or more conditions of the channel or the STA. For example, the threshold may be reduced when the STA detects that the STA has moved physical locations (e.g., by sensors or GPS data) by more than a predetermined amount. A change in physical location may indicate the data should be refreshed even if it is recent because of the different physical environment or position of the STA. After the STA has the channel information, either by a scan according to block 706 or by the use of stored data according to block 710, then the STA will use the acquired channel condition data to calculate the pre-probe wait time at operation 712 according to the process of FIG. 5, calculate the post-probe wait time according to the process of FIG. 6, or both.

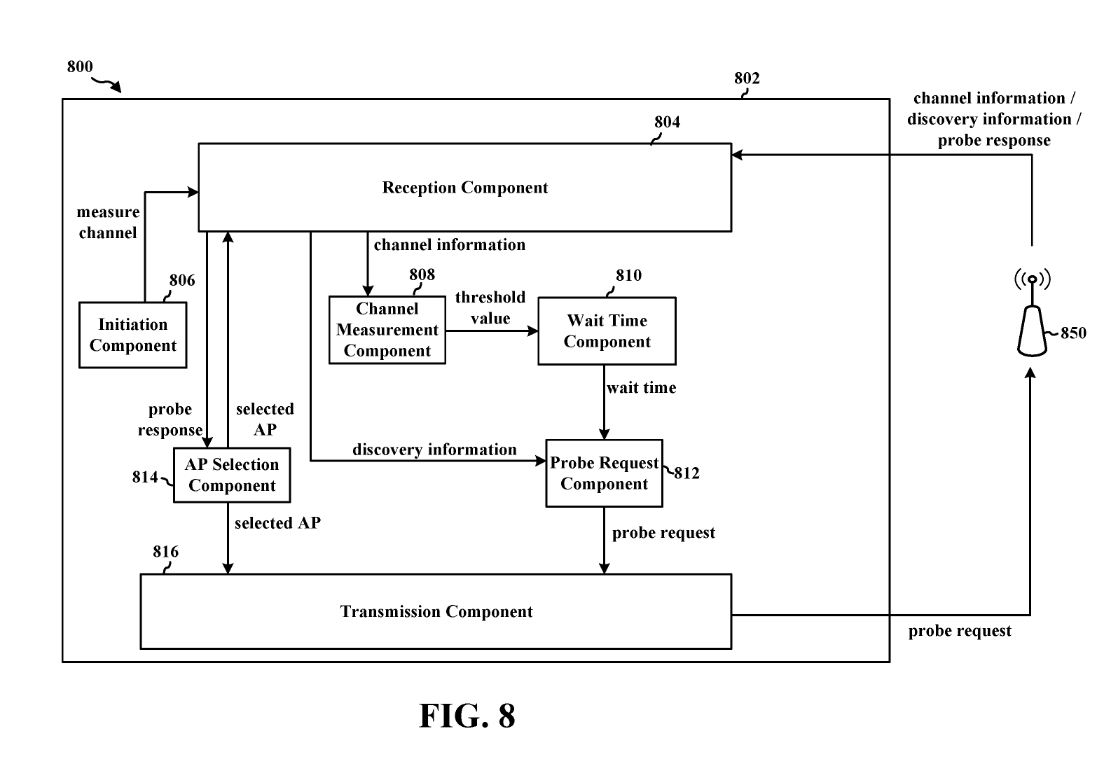

FIG. 8 is a conceptual data flow diagram 800 illustrating the data flow between different means/components in an exemplary apparatus 802. The apparatus 802 may be a STA (e.g., STA 115, 115a-115e, the apparatus 802′, 1002/1002′, 1202/1202′) or AP (e.g., AP 105, 105-a, 105-b) in communication with at least one other AP 850 (e.g., AP 105, 105-a, 105-b, 1050, 1250). The apparatus may include a reception component 804, an initiation component 806, a channel measurement component 808, a wait time component 810, a probe request component 812, an AP selection component 814, and a transmission component 816.

The initiation component 806 may be configured to initiate a post-probe wait time calculation, e.g., as described in connection with 502 in FIG. 5. The initiation component 806 may be configured to send a signal to one or more of the reception component 804, the channel measurement component 808, and/or the wait time component 810 instructing one or more of the components to calculate a post-probe wait time.

One or more of the reception component 804 and/or the channel measurement component 808 may be configured to scan the chosen channel to determine the current channel conditions, such as by measuring one or more channel condition metrics. For example, the reception component 804 may be configured to receive channel information from the AP 850 and send the channel information to the channel measurement component 808. The channel measurement component 808 may be configured to determine the current channel conditions based at least in part on the channel information, e.g., as described in connection with 504 in FIG. 5.

In certain implementations, the channel measurement component 808 may be configured to compare a channel condition value (e.g., a CCA value or an alternative value that represents the conditions on the channel, such as congestion) to one or more predetermined thresholds, e.g., as described in connection with 506 in FIG. 5. The threshold value determined by comparing the channel conditions to the one or more predetermined thresholds may be sent to the wait time component 810.

The wait time component 810 may be configured to calculate the appropriate pre-probe wait time depending on channel conditions, e.g., as described in connection with 508 in FIG. 5. The calculated wait time may be sent to the probe request component 812.

The probe request component 812 may be configured to wait for the amount of wait time before transmitting any probe requests (or any similar discovery response trigger frames, which are intended to be within the scope of the term probe request), e.g., as described in connection with 510 in FIG. 5. During the wait time, the reception component 804 and/or the probe request component 812 may be configured to actively listen for any incoming discovery frames.

The reception component 804 may be configured to receive discovery information from the AP 850, and send any discovery information received during the wait time to the probe request component 812.

The probe request component 812 may be configured to determine whether any additional discovery information is needed to complete a desired AP association, e.g., as described in connection with 512 in FIG. 5. The probe request component 812 may be configured to generate a probe request after the expiration of the wait time and upon determining additional discovery information is needed to component the desired AP association. The probe request may be sent to the transmission component 816. The transmission component 816 may be configured to send the probe request to the AP 850, e.g., as described in connection with 514 in FIG. 5.

The reception component 804 may be configured to receive one or more probe responses or other discovery responses (e.g., discovery information), e.g., as described in connection with 516 in FIG. 5, and send the probe responses and/or discovery information to the AP selection component 814.

The AP selection component 814 may be configured to analyze the received discovery data and selects the desired AP for association that meets its performance standards, requested service type, or any other qualification standards, e.g., as described in connection with 518 in FIG. 5.

The apparatus may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

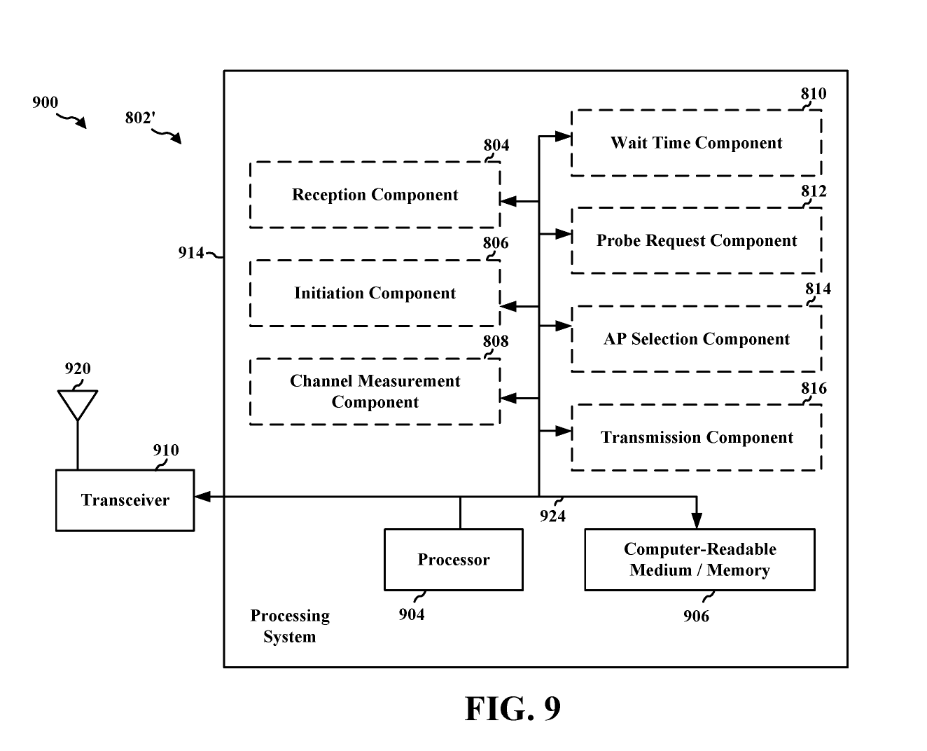

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, 814, 816 and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 816, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812, 814, 816. The components may be software components running in the processor 904, resident/stored in the computer readable medium/memory 906, one or more hardware components coupled to the processor 904, or some combination thereof.

In certain configurations, the apparatus 802/802′ for wireless communication may include means for initiating a post-probe wait time calculation, e.g., as described in connection with 502 in FIG. 5. In certain other configurations, the apparatus 802/802′ for wireless communication may include means for scanning the chosen channel to determine the current channel conditions, such as by measuring one or more channel condition metrics, e.g., as described in connection with 504 in FIG. 5. In certain other configurations, the apparatus 802/802′ for wireless communication may include means for determining the current channel conditions based at least in part on the channel information, e.g., as described in connection with 504 in FIG. 5. In certain other configurations, the apparatus 802/802′ for wireless communication may include means for comparing a channel condition value (e.g., a CCA value or an alternative value that represents the conditions on the channel, such as congestion) to one or more predetermined thresholds, e.g., as described in connection with 506 in FIG. 5. In certain other configurations, the apparatus 802/802′ for wireless communication may include means for calculating the appropriate pre-probe wait time depending on channel conditions, e.g., as described in connection with 508 in FIG. 5. In certain other configurations, the apparatus 802/802′ for wireless communication may include means for waiting for the amount of wait time before transmitting any probe requests (or any similar discovery response trigger frames, which are intended to be within the scope of the term probe request), e.g., as described in connection with 510 in FIG. 5. In certain other configurations, the apparatus 802/802′ for wireless communication may include means for receiving discovery information from the AP, e.g., as described in connection with 516 in FIG. 5. In certain other configurations, the apparatus 802/802′ for wireless communication may include means for determining whether any additional discovery information is needed to complete a desired AP association, e.g., as described in connection with 512 in FIG. 5. In certain other configurations, the apparatus 802/802′ for wireless communication may include means for sending the probe request to the AP 850, e.g., as described in connection with 514 in FIG. 5. In certain other configurations, the apparatus 802/802′ for wireless communication may include means for receiving one or more probe responses or other discovery responses (e.g., discovery information), e.g., as described in connection with 516 in FIG. 5. In certain other configurations, the apparatus 802/802′ for wireless communication may include means for analyzing the received discovery data and selecting the desired AP for association that meets its performance standards, requested service type, or any other qualification standards, e.g., as described in connection with 518 in FIG. 5. The aforementioned means may be the transceiver 306, radio 307, transmitter 308, receiver 315, memory 330, processor(s) 303, modem 356, the discover and association component 340, the transceiver 406, the first radio 407, the transmitter 408, the receiver 409, the second radio 415, the transmitter 416, the receiver 417, memory 430, the processor(s) 403, the modem 465, the discover and association component 440, one or more of the aforementioned components of the apparatus 802 and/or the processing system 914 of the apparatus 802′ configured to perform the functions recited by the aforementioned means.

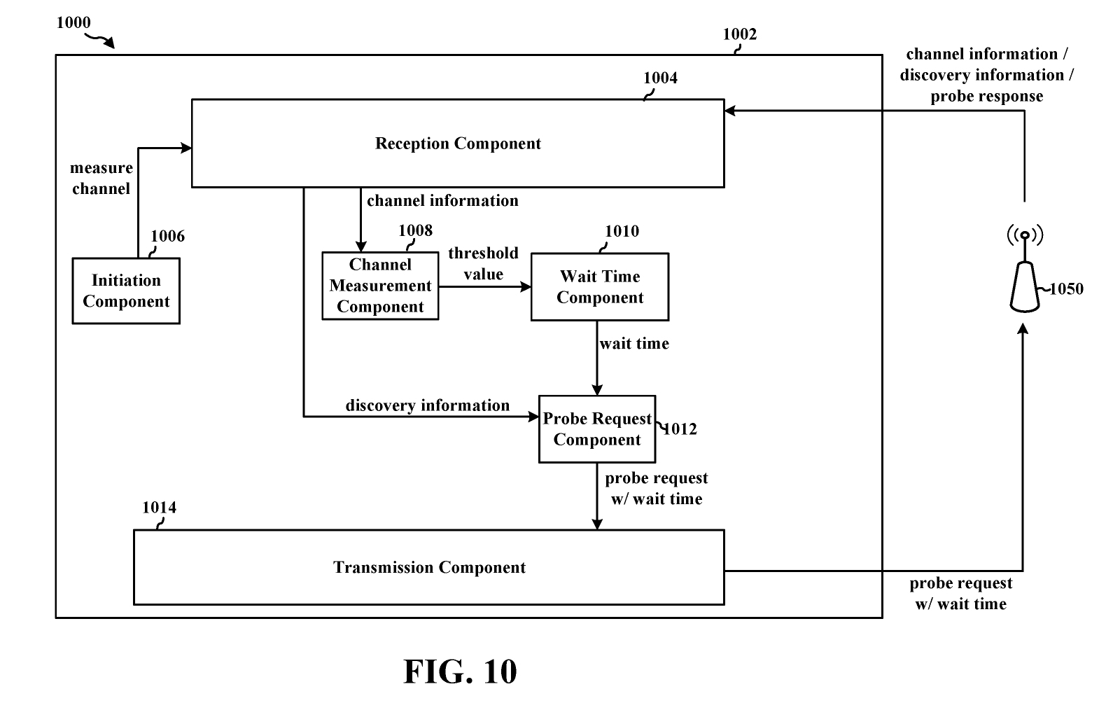

FIG. 10 is a conceptual data flow diagram 1000 illustrating the data flow between different means/components in an exemplary apparatus 1002. The apparatus 1002 may be a STA (e.g., STA 115, 115a-115e, the apparatus 802/802′, 1002′, 1202/1202′) or AP (e.g., AP 105, 105-a, 105-b) in communication with at least one other AP 1050 (e.g., AP 105, 105-a, 105-b, 850, 1250). The apparatus may include a reception component 1004, an initiation component 1006, a channel measurement component 1008, a wait time component 1010, a probe request component 1012, and a transmission component 1014.

The initiation component 1006 may be configured to initiate a post-probe wait time calculation, e.g., as described in connection with 602 in FIG. 6. The initiation component 1006 may be configured to send a signal to one or more of the reception component 1004, the channel measurement component 1008, and/or the wait time component 1010 instructing one or more of the components to calculate a post-probe wait time.

One or more of the reception component 1004 and/or the channel measurement component 1008 may be configured to scan the chosen channel to determine the current channel conditions, such as by measuring one or more channel condition metrics, e.g., as described in connection with 604 in FIG. 6. For example, the reception component 1004 may be configured to receive channel information from the AP 1050 and send the channel information to the channel measurement component 1008. The channel measurement component 1008 may be configured to determine the current channel conditions based at least in part on the channel information.

The channel measurement component 1008 may be configured to compare a channel condition value (e.g., a CCA value or an alternative value that represents the conditions on the channel, such as congestion) to one or more predetermined thresholds, e.g., as described in connection with 606 in FIG. 6. The threshold value determined by comparing the channel conditions to the one or more predetermined thresholds may be sent to the wait time component 1010.

The wait time component 1010 may be configured to calculate the appropriate post-probe wait time depending on channel conditions, e.g., as described in connection with 608 in FIG. 6. The wait time component 1010 may be configured to send the calculated wait time to the probe request component 1012.

The probe request component 1012 may be configured to generate a probe request that includes the information related to the wait time after the expiration of the wait time and upon determining additional discovery information is needed to component the desired AP association. The probe request may be sent to the transmission component 1014. The transmission component 1014 may be configured to send the probe request to the AP 1050, e.g., as described in connection with 610 in FIG. 6.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

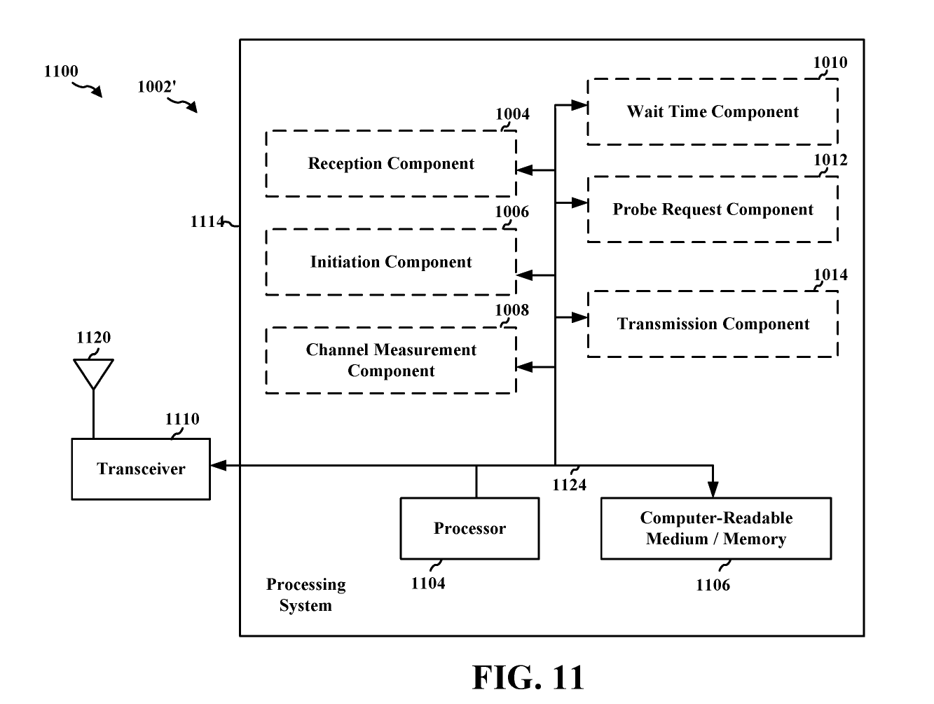

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, 1012, 1014 and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1014, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1010, 1012, 1014. The components may be software components running in the processor 1104, resident/stored in the computer readable medium/memory 1106, one or more hardware components coupled to the processor 1104, or some combination thereof.

In certain configurations, the apparatus 1002/1002′ for wireless communication may include means for initiating a post-probe wait time calculation, e.g., as described in connection with 602 in FIG. 6. In certain other configurations, the apparatus 1002/1002′ for wireless communication may include means for scanning the chosen channel to determine the current channel conditions, such as by measuring one or more channel condition metrics, e.g., as described in connection with 604 in FIG. 6. In certain other configurations, the apparatus 1002/1002′ for wireless communication may include means for comparing a channel condition value (e.g., a CCA value or an alternative value that represents the conditions on the channel, such as congestion) to one or more predetermined thresholds, e.g., as described in connection with 606 in FIG. 6. In certain other configurations, the apparatus 1002/1002′ for wireless communication may include means for calculating the appropriate post-probe wait time depending on channel conditions, e.g., as described in connection with 608 in FIG. 6. In certain other configurations, the apparatus 1002/1002′ for wireless communication may include means for sending the probe request to the AP 1050, e.g., as described in connection with 610 in FIG. 6. The aforementioned means may be the transceiver 306, radio 307, transmitter 308, receiver 315, memory 330, processor(s) 303, modem 356, the discover and association component 340, the transceiver 406, the first radio 407, the transmitter 408, the receiver 409, the second radio 415, the transmitter 416, the receiver 417, memory 430, the processor(s) 403, the modem 465, the discover and association component 440, one or more of the aforementioned components of the apparatus 1002 and/or the processing system 1114 of the apparatus 1002′ configured to perform the functions recited by the aforementioned means.

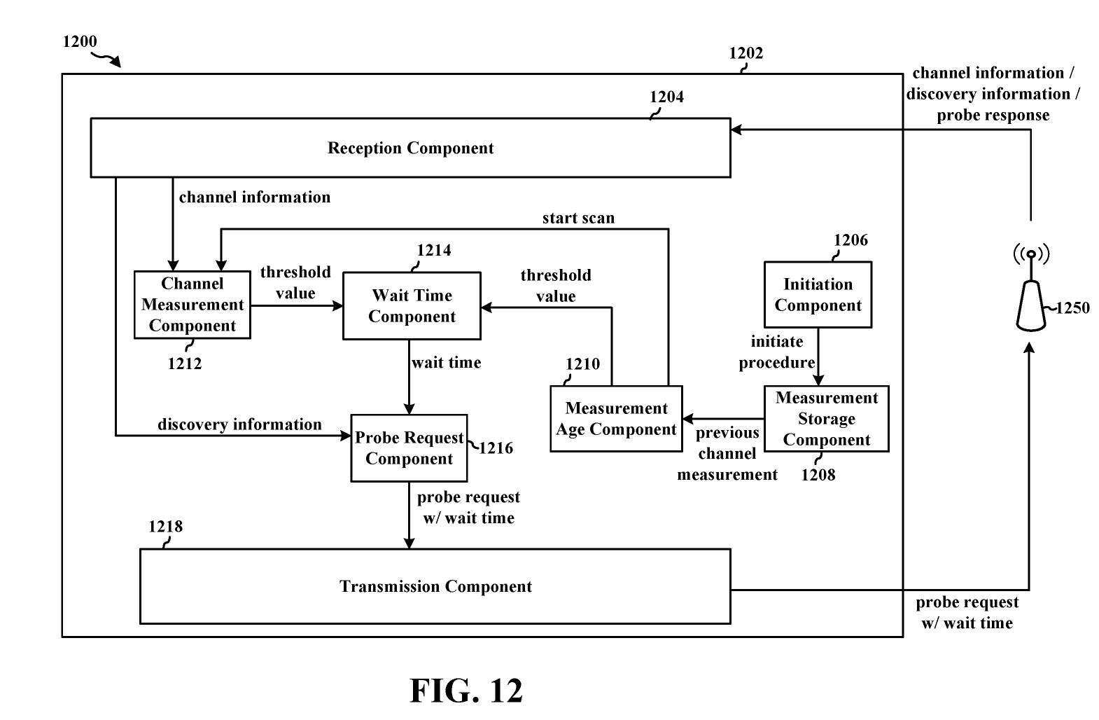

FIG. 12 is a conceptual data flow diagram 1200 illustrating the data flow between different means/components in an exemplary apparatus 1202. The apparatus 1202 may be a STA (e.g., STA 115, 115a-115e, the apparatus 802/802′, 1002/1002′, 1202′) or AP (e.g., AP 105, 105-a, 105-b) in communication with at least one other AP 1250 (e.g., AP 105, 105-a, 105-b, 850, 1050). The apparatus may include a reception component 1204, an initiation component 1206, a measurement storage component 1208, a measurement age component 1210, a channel measurement component 1212, a wait time component 1214, a probe request component 1216, and a transmission component 1218.

The initiation component 1206 may be configured to initiate a scan procedure, e.g., as described in connection with 702 in FIG. 7. The initiation component 1206 may be configured to send a signal to the measurement storage component 1208 indicating to initiate a scan procedure.

The measurement storage component 1208 may be configured to determine if saved data is available, e.g., as described in connection with 704 in FIG. 7. If no stored channel condition data is available, then the measurement storage component 1208 may send a signal instructing the channel measurement component 1212 to initiate a channel scan procedure, e.g., as described in connection with block 504 of FIG. 5 and block 604 of FIG. 6). The results of the scan may then be maintained for future use by the measurement storage component 1208, e.g., as described in connection with 706 in FIG. 7.

Alternatively, if stored channel condition information is located by the measurement storage component 1208, the measurement storage component 1208 may send the stored channel measurement to the measurement age component 1210.

The measurement age component 1210 may be configured to determine whether the stored information is recent enough to be a reliable indicator of the current channel conditions, e.g., as described in connection with 708 in FIG. 7.

If the measurement age component 1210 determines that the amount of time that has passed between the time stamp and the current time is greater than the threshold, the measurement age component 1210 may send a signal instructing the channel measurement component 1212 to a channel scan procedure (as described in connection with block 504 of FIG. 5 and block 604 of FIG. 6).

Alternatively, the measurement age component 1210 determines that the amount of time that has passed between the time stamp and the current time is less than the threshold, the measurement age component 1210 may send the previous channel measurement and/or threshold value to the wait time component 1214. The wait time component 1214 may be configured to use the stored data instead of requiring a new channel scan in order to determine the wait time, e.g., as described in connection with 712.

One or more of the reception component 1204 and/or the channel measurement component 1212 may be configured to scan the chosen channel to determine the current channel conditions, such as by measuring one or more channel condition metrics, when a new channel scan is performed (e.g., no data is maintained by the measurement storage component 1208 and/or the maintained data is determined to be unusable by the measurement age component 1210). For example, the reception component 1204 may be configured to receive channel information from the AP 1250 and send the channel information to the channel measurement component 1212. The channel measurement component 1212 may be configured to determine the current channel conditions based at least in part on the channel information.

The channel measurement component 1212 may be configured to compare a channel condition value (e.g., a CCA value or an alternative value that represents the conditions on the channel, such as congestion) to one or more predetermined thresholds. The threshold value determined by comparing the channel conditions to the one or more predetermined thresholds may be sent to the wait time component 1214.

The wait time component 1214 may be configured to calculate the appropriate post-probe wait time depending on channel conditions, e.g., as described in connection with 712 in FIG. 7. The wait time component 1214 may be configured to send the calculated wait time to the probe request component 1216.

The probe request component 1216 may be configured to generate a probe request that includes the information related to the wait time after the expiration of the wait time and upon determining additional discovery information is needed to component the desired AP association. The probe request may be sent to the transmission component 1216. The transmission component 1216 may be configured to send the probe request to the AP 1250.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

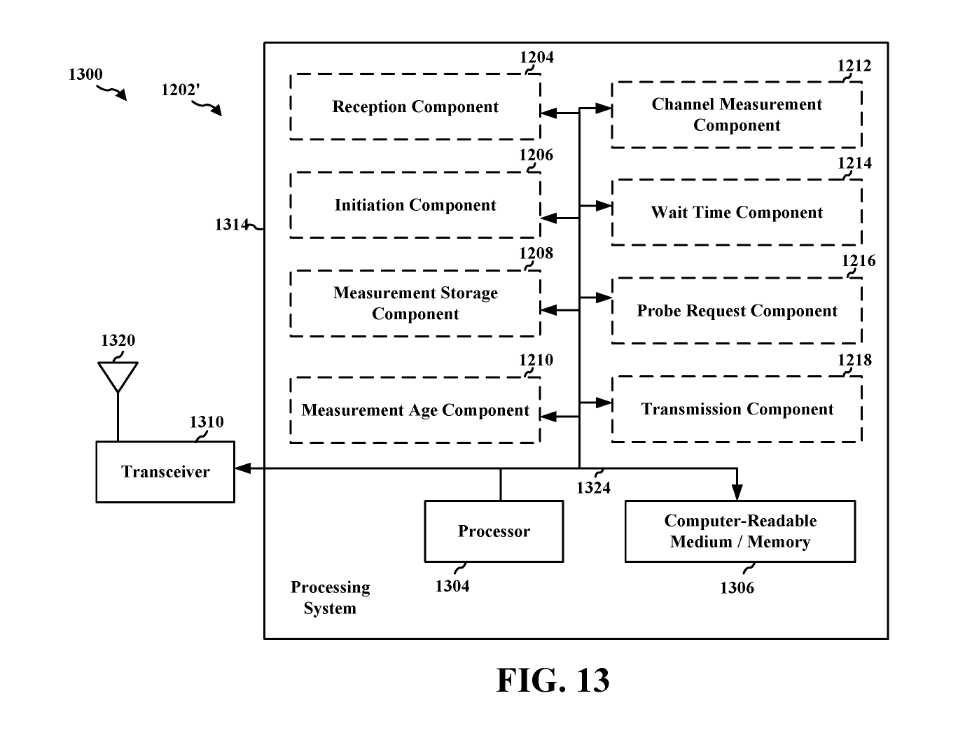

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor 1304, the components 1204, 1206, 1208, 1210, 1212, 1214, 1216, 1218, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1204. In addition, the transceiver 1310 receives information from the processing system 1314, specifically the transmission component 1218, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system 1314 further includes at least one of the components 1204, 1206, 1208, 1210, 1212, 1214, 1216, 1218. The components may be software components running in the processor 1304, resident/stored in the computer readable medium/memory 1306, one or more hardware components coupled to the processor 1304, or some combination thereof.

In certain configurations, the apparatus 1202/1202′ for wireless communication may include means for initiating a scan procedure, e.g., as described in connection with 702 in FIG. 7. In certain other configurations, the apparatus 1202/1202′ for wireless communication may include means for determining if saved data is available, e.g., as described in connection with 704 in FIG. 7. In certain other configurations, the apparatus 1202/1202′ for wireless communication may include means for determining whether the stored information is recent enough to be a reliable indicator of the current channel conditions, e.g., as described in connection with 708 in FIG. 7. In certain other configurations, the apparatus 1202/1202′ for wireless communication may include means for determining a wait time based on the stored data instead of requiring a new channel scan, e.g., as described in connection with 710 and 712 in FIG. 7. In certain other configurations, the apparatus 1202/1202′ for wireless communication may include means for scanning a channel and saving the results, e.g., as described in connection with 706 in FIG. 7. The aforementioned means may be the transceiver 306, radio 307, transmitter 308, receiver 315, memory 330, processor(s) 303, modem 356, the discover and association component 340, the transceiver 406, the first radio 407, the transmitter 408, the receiver 409, the second radio 415, the transmitter 416, the receiver 417, memory 430, the processor(s) 403, the modem 465, the discover and association component 440, one or more of the aforementioned components of the apparatus 1202 and/or the processing system 1314 of the apparatus 1202′ configured to perform the functions recited by the aforementioned means.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable sub-combination. As such, although features may be described above as acting in particular combinations, and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on. Furthermore, although certain aspects may be described or claimed in the singular, the plural is contemplated unless limitation to the singular is explicitly stated.

What is claimed is:

1. A method for wireless communication, comprising:
identifying a channel for use by a wireless communication device;
determining one or more channel conditions associated with the channel; and
selecting, based on the one or more channel conditions, a value for a pre-probe wait time, from multiple possible pre-probe wait time values, for the wireless communication device to wait before sending a probe request on the channel.

2. The method of claim 1, further comprising determining whether to send the probe request on the channel after expiration of the pre-probe wait time.

3. The method of claim 2, wherein determining whether to send the probe request comprises:
receiving a discovery frame associated with an access point before expiration of the pre-probe wait time;
selecting to associate with the access point based on the discovery frame; and
determining to not send the probe request based on the selection of the access point for association.

4. The method of claim 3, wherein the discovery frame is a beacon frame, a broadcast probe response frame, or a Fast Initial Link Setup (FILS) frame.

5. The method of claim 2, wherein determining whether to send the probe request comprises:
determining that additional discovery information from one or more access points is desired; and
transmitting the probe request to the one or more access points after expiration of the pre-probe wait time.

6. The method of claim 2, wherein determining whether to send the probe request comprises:
receiving a discovery frame associated a first access point before expiration of the pre-probe wait time;
determining that additional discovery information from one or more other access points is still desired; and
transmitting the probe request that includes an indication for the first access point to suppress any probe response from the first access point in response to the probe request.

7. The method of claim 1, wherein determining the one or more channel conditions comprises performing a scan on the channel to measure the one or more channel conditions.

8. The method of claim 7, wherein the one or more channel conditions comprise a clear channel assessment score that indicates a congestion level on the channel.

9. The method of claim 1, wherein determining the one or more channel conditions comprises:
retrieving a stored clear channel assessment score from a storage device that indicates a congestion level on the channel; and
comparing an age of the stored clear channel assessment score to a threshold age to determine whether to use the stored clear channel assessment score or trigger a new scan to determine a new clear channel assessment score.

10. The method of claim 1, wherein selecting the pre-probe wait time comprises selecting a shorter amount of time if the one or more channel conditions indicate a relatively lower congestion level than if the one or more channel conditions indicated a relatively higher congestion level.

11. The method of claim 1, wherein selecting the pre-probe wait time comprises:
comparing a channel condition value associated with the one or more channel conditions against a first threshold; and
selecting between the pre-probe wait time being a first time value or a second time value, different than the first time value, depending on whether the channel condition value is above the first threshold or below the first threshold.

12. The method of claim 1, wherein selecting the pre-probe wait time comprises:
comparing a channel condition value associated with the one or more channel conditions against a first threshold;
comparing the channel condition value against a second threshold; and
selecting between the pre-probe wait time being a first time value, a second time value different that the first time value, or a third time value different than the first time value and the second time value, depending on whether the channel condition value is below the first threshold, above the second threshold, or between the first threshold and the second threshold.

13. The method of claim 1, wherein determining the one or more channel conditions comprises:
receiving a request to send (RTS) frame or a clear to send (CTS) frame; and
calculating a channel condition value associated with the one or more channel conditions based on information from the RTS frame or the CTS frame; and
wherein selecting the value for the pre-probe wait time comprises selecting the value for the pre-probe wait time based on the channel condition value.

14. The method of claim 1, wherein the method is performed on a mobile station, the method further comprising transmitting the probe request through a transmitter and an antenna of the mobile station to an access point.

15. The method of claim 1, wherein the method is performed on a first access point, the method further comprising transmitting the probe request through a transmitter and an antenna of the first access point to a second access point.

16. A method for wireless communication, comprising:
identifying a channel for use by a wireless communication device;
determining one or more channel conditions associated with the channel;
selecting, based on the one or more channel conditions, a value for a post-probe wait time, from multiple possible post-probe wait time values, that the wireless communication device will remain on the channel after sending a probe request on the channel; and
sending the probe request on the channel with an indication of the post-probe wait time.

17. The method of claim 16, wherein determining the one or more channel conditions comprises performing a scan on the channel to measure the one or more channel conditions.

18. The method of claim 17, wherein the one or more channel conditions comprise a clear channel assessment score that indicates a congestion level on the channel.

19. The method of claim 16, wherein determining the one or more channel conditions comprises:
retrieving a stored clear channel assessment score from a storage device that indicates a congestion level on the channel; and
comparing an age of the stored clear channel assessment score to a threshold age to determine whether to use the stored clear channel assessment score or trigger a new scan to determine a new clear channel assessment score.

20. The method of claim 16, wherein selecting the post-probe wait time comprises selecting a shorter time if the one or more channel conditions indicate a relatively lower congestion level than if the one or more channel conditions indicated a relatively higher congestion level.

21. The method of claim 16, wherein selecting the post-probe wait time comprises:
comparing a channel condition value associated with the one or more channel conditions against a first threshold; and
selecting between the post-probe wait time being a first time value or a second time value, different than the first time value, depending on whether the channel condition value is above the first threshold or below the first threshold.

22. The method of claim 16, wherein selecting the post-probe wait time comprises:
comparing a channel condition value associated with the one or more channel conditions against a first threshold;
comparing the channel condition value against a second threshold; and
selecting between the post-probe wait time being a first time value, a second time value different than the first time value, or a third time value different than the first time value and the second time value, depending on whether the channel condition value is below the first threshold, above the second threshold, or between the first threshold and the second threshold.

23. The method of claim 16, further comprising:
receiving one or more discovery frames associated with one or more access points before expiration of the post-probe wait time;
selecting to associate with a first access point of the one or more access points based on information received in at least one of the one or more discovery frames.

24. The method of claim 23, wherein the one or more discovery frames comprise a probe response addressed to the wireless communication device, a broadcast probe response frame, a beacon frame, or a Fast Initial Link Setup (FILS) frame.

25. The method of claim 16, wherein determining the one or more channel conditions comprises:
receiving a request to send (RTS) frame or a clear to send (CTS) frame; and
calculating a channel condition value associated with the one or more channel conditions based on information from the RTS frame or the CTS frame; and
wherein selecting the value for the post-probe wait time comprises selecting the value for the post-probe wait time based on the channel condition value.

26. The method of claim 16, wherein the method is performed on a mobile station, the method further comprising transmitting the probe request through a transmitter and an antenna of the mobile station to an access point.

27. The method of claim 16, wherein the method is performed on a first access point, the method further comprising transmitting the probe request through a transmitter and an antenna of the first access point to a second access point.

28. A method for wireless communication, comprising:
identifying a channel for use by a wireless communication device;
determining one or more channel conditions associated with the channel;
selecting, based on the one or more channel conditions, a value for a minimum wait time from multiple possible minimum wait time values, wherein the minimum wait time represents an amount of time that the wireless communication device will wait before sending a probe request on the channel or an amount of time that the wireless communication device will remain on the channel after sending the probe request on the channel; and
sending the probe request on the channel based on the minimum wait time.

29. The method of claim 28, wherein the minimum wait time is a pre-probe wait time for the wireless communication device to wait before sending the probe request on the channel; and
wherein sending the probe request based on the minimum wait time comprises waiting for the minimum wait time before sending the probe request on the channel.

30. A method for wireless communication, comprising:
identifying a channel for use by a wireless communication device;
determining one or more channel conditions associated with the channel;
selecting, based on the one or more channel conditions, a value for a pre-probe wait time, from multiple possible pre-probe wait time values, for the wireless communication device to wait before sending a probe request on the channel;
selecting, based on the one or more channel conditions, a value for a post-probe wait time, from multiple possible post-probe wait time values, that the wireless communication device will remain on the channel after sending the probe request on the channel; and
sending the probe request on the channel after expiration of the pre-probe wait time with an indication of the post-probe wait time.
